(19) United States
(12) Patent Application Publication
(10) Pub. No.: US 2016/0249733 A1
(43) Pub. Date: Sep. 1, 2016

(54) BOTTLE BRUSH

(71) Applicant: Munchkin, Inc., Van Nuys, CA (US)

(72) Inventors: Mark Gerard Tebbe, Ventura, CA (US); Steven B. Dunn, Beverly Hills, CA (US); Mark A. Hatherill, Beverly Hills, CA (US); Yong Sun Simon Kang, Pasadena, CA (US); Sung Yun Chan, Pasadena, CA (US); Thomas E. Birkert, West Hills, CA (US)

(21) Appl. No.: 15/055,490

(22) Filed: Feb. 26, 2016

Related U.S. Application Data
(60) Provisional application No. 62/287,381, filed on Jan. 26, 2016.
(60) Provisional application No. 62/121,457, filed on Feb. 26, 2015.

(51) Int. Cl. A46B 5/00; B08B 9/087; A46B 15/00; B25G 1/08; B25G 1/02; B08B 1/00

(52) U.S. Cl. CPC A46B 5/0037; B25G 1/02; B08B 1/002; A46B 5/0016; A46B 15/0097; B25G 1/08; B08B 9/087

(57) ABSTRACT

Modular and flexible brush systems are disclosed having multiple interchangeable parts that have different functions. A base portion contains a nipple brush. A handle portion includes various internal connecting mechanisms and stores the nipple brush. A top portion includes a bottle brush and has a flexible neck portion.

### CROSS REFERENCE TO RELATED APPLICATIONS

This application claims priority to U.S. Provisional Patent Application Ser. No. 62/287,381, filed Jan. 26, 2016; and to U.S. Provisional Patent Application Ser. No. 62/121,457, filed Feb. 26, 2015; the contents of which are hereby incorporated by reference herein in their entirety into this disclosure.

### TECHNICAL FIELD

The subject disclosure relates to the field of cleaning and, in particular, to improved cleaning devices for cleaning infant nursing bottles and nipples that are hygienically flexible and versatile.

### BACKGROUND

The importance of proper hygiene when handling and cleaning infant feeding tools, such as baby bottles, and nursing nipples cannot be overstated. Ideally, bottles and nipples should be thoroughly scrubbed. Proper scrubbing is especially important after a nipple or bottle has been used to dispense fatty liquids, or liquids having suspended solids therein, such as cereal. Removing food from tight corners and difficult contours in a bottle can be quite challenging. Although various solutions have been proposed, none available has effectively solved the issue of thoroughly cleaning the various contours of a container and/or other items to be cleaned.

### SUMMARY OF THE SUBJECT MATTER

In one exemplary embodiment, the subject disclosure is a device to scrub a container. The device includes a rigid handle comprising a first core portion and a second core portion, the first and second core portions connected internally within the handle; a flexible portion removably connected to the handle and including a resilient material of a predetermined hardness, the flexible portion adapted to bend relative to a longitudinal axis of the handle; and a first brush operatively connected to the flexible portion and sized to efficiently scrub an inside of the container as the flexible portion bends.

I n another exemplary embodiment, the subject disclosure is a device to scrub a container. The device includes a handle having a first core and a second core; a flexible top portion removably connected to the handle with a resilient material of a predetermined hardness disposed in at least one gap, the flexible top portion adapted to bend at a predetermined angle relative to a longitudinal axis of the handle; a brush operatively connected to the flexible portion and the first core within the handle, and sized to efficiently scrub an inside of the container as the flexible handle bends; and a second brush operatively connected to the second core and received within the handle.

In yet another exemplary embodiment, the subject disclosure is a device to scrub a container. The device includes a handle having a first core and a second core; a flexible top portion having a neck removably connected to the handle with a resilient material of a predetermined hardness disposed around the neck, the flexible top portion adapted to bend at a predetermined angle relative to a longitudinal axis of the handle; a brush operatively connected to the flexible top portion and the first core within the handle, and sized to efficiently scrub an inside of the container as the flexible handle bends; and a second brush operatively connected to the second core and received within the handle.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a brush having a flexible neck, according to an exemplary embodiment of the present subject matter.

FIG. 2 depicts the exemplary brush in an unbent configuration.

FIG. 3 shows an embedded smaller brush within the handle of the brush.

FIG. 4 illustrates an enlarged view of the neck of the flexible handle of the brush.

FIG. 5 depicts an enlarged cross section view of the neck of the flexible handle of the brush.

FIG. 6 shows the enlarged cross section view of the neck of the flexible handle slightly bent.

FIG. 7 illustrates the enlarged cross section view of the neck of the flexible handle sufficiently bent.

FIG. 8 depicts an enlarged cross section view of the neck of the flexible handle with the resilient material.

FIG. 9 shows the enlarged cross section view of the neck of the flexible handle with the resilient material slightly bent.

FIG. 10 illustrates the enlarged cross section view of the neck of the flexible handle with the resilient material sufficiently bent.

FIG. 11 depicts an enlarged cross section view of the neck of the flexible handle including another configuration for the resilient material.

FIG. 12 shows an enlarged cross section spine-like configuration of the neck of the flexible handle, according to another exemplary embodiment of the present subject matter.

FIG. 13 shows an enlarged cross section spine-like configuration of the neck of the flexible handle, according to another exemplary embodiment of the present subject matter.

FIG. 14 shows an enlarged cross section spine-like configuration of the neck of the flexible handle, according to another exemplary embodiment of the present subject matter.

FIG. 15 shows an enlarged cross section spine-like configuration of the neck of the flexible handle, according to another exemplary embodiment of the present subject matter.

FIG. 16 shows an enlarged cross section spine-like configuration of the neck of the flexible handle, according to another exemplary embodiment of the present subject matter.

FIG. 17 shows an enlarged cross section spine-like configuration of the neck of the flexible handle, according to another exemplary embodiment of the present subject matter.

FIG. 18 illustrates a brush having a flexible neck, according to another exemplary embodiment of the present subject matter.

FIG. 19 shows a top view of a brush, without bristles, according to another exemplary embodiment of the present subject matter.

FIG. 20 shows a bottom view of a brush, without bristled, according to another exemplary embodiment of the present subject matter.

FIG. 21 shows an exploded view of a brush showing its various components, according to another exemplary embodiment of the present subject matter.

FIG. 22 shows a cross sectional view of the brush of FIG. 21, according to an exemplary embodiment of the present subject matter.

FIG. 23 shows a cross sectional view of the brush of FIG. 22 with all components in position and showing its various components, according to another exemplary embodiment of the present subject matter.

FIG. 24 shows a cross sectional view of the brush of FIG. 21, according to another exemplary embodiment of the present subject matter.

FIG. 25 shows a cross sectional view of the brush of FIG. 24 with all components in position and showing its various components, according to another exemplary embodiment of the present subject matter.

### DETAILED DESCRIPTION

Particular embodiments of the present invention will now be described in greater detail with reference to the figures.

The subject disclosure is described with reference to the drawings, wherein like reference numerals are used to refer to like elements throughout. In the following description, for purposes of explanation, numerous specific details are set forth in order to provide a thorough understanding of the present disclosure. It may be evident, however, that the present disclosure may be practiced without these specific details.

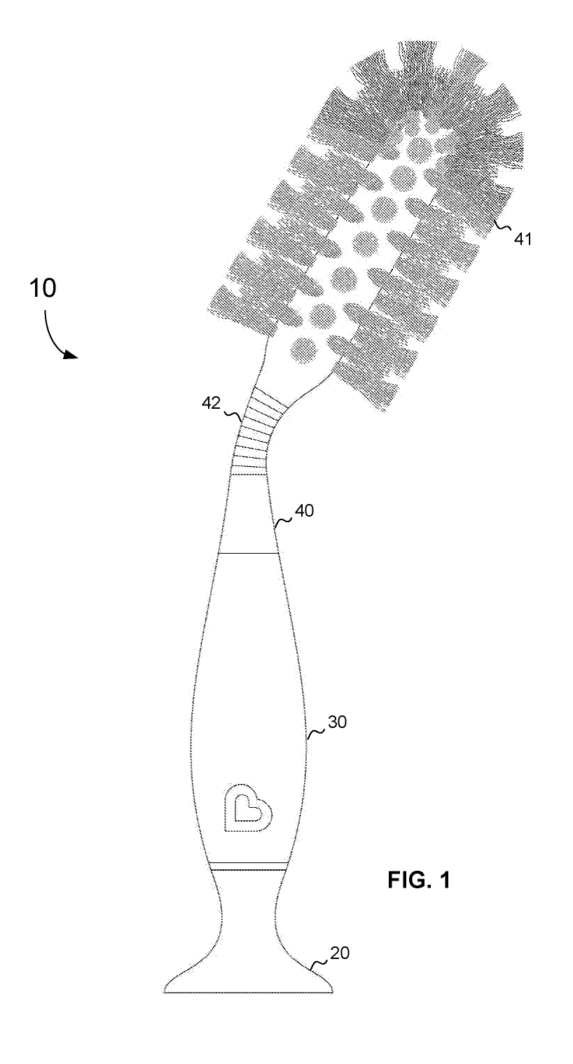

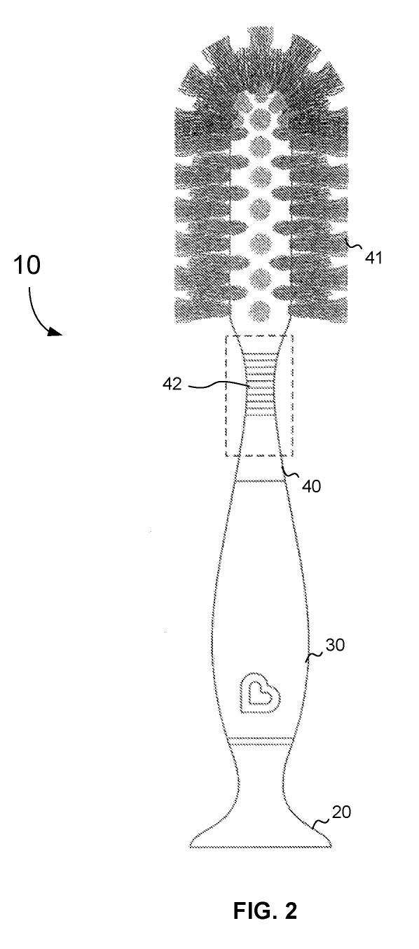

FIGS. 1-2 illustrate an exemplary embodiment of the present subject matter presented as a modular brush system 10 having a base portion 20, a handle portion 30 and a flexible top portion 40 having bristles 41 and a flexible neck region 42. All of the embodiments shown in the present application contain these three components so they will all be similarly labeled.

FIG. 1 shows a natural bend in the next region 42, and FIG. 2 shows a straightened neck portion. However, in various embodiments, the neck portion 42 may be naturally straight and allowed to bend with force. This ability for the neck portion 42 to flex with moderate force allows for the bristles 41 to move around within the interior of a bottle from various positions of the handle 30.

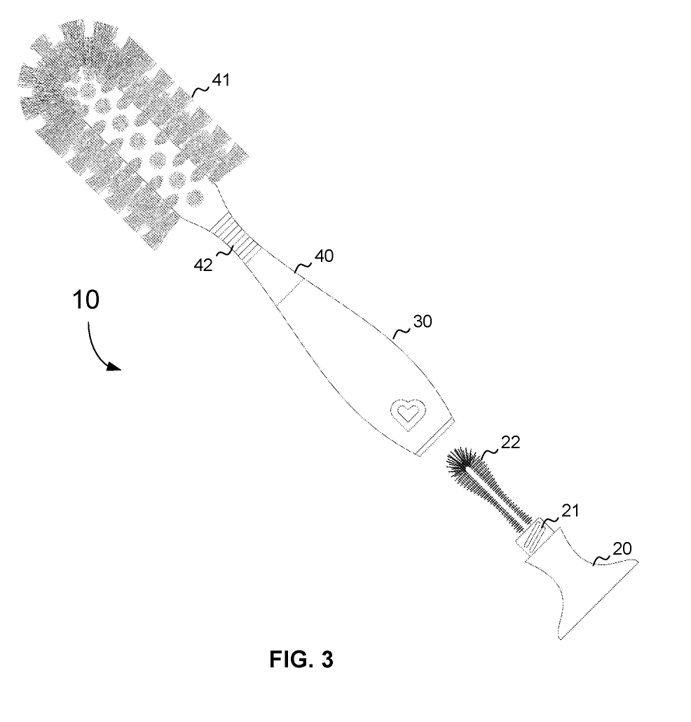

FIG. 3 shows a combined top bottle bristles 42 and nipple bristles 22 adapted to fit within the handle 30 of the bottle brush device 10. The nipple brush 22 extends from a threaded portion 21 of the base 20. The modular and flexible brush system 10 is configured to conveniently scrub baby bottles using top brush 42 and nursing nipples for such bottles using internal brush 22.

The handle 30 may include a resilient outer grip surface. The outer grip may be fabricated from a resilient polymeric material that is dishwasher-proof, such as polycarbonate, an ABS plastics or other suitable material. The handle 30 may be configured to receive a nipple brush assembly 22 as shown in FIG. 3.

In FIG. 3, the brush handle 30 may have a longitudinally oriented recess defined therein to receive a smaller nipple brush 22. The bottle brush 41 is sized and configured to efficiently scrub an inside of a baby bottle. The bristles 41 of the brush may be connected by a flexible stem. The flexible stem may include a bristle end or a sponge-like end for scrubbing. The brush may be cylindrical in shape and/or any other suitable shape for scrubbing purposes.

The nipple brush assembly may include a nipple brush portion 22 and a grip portion at the base 20. The grip portion may be constructed in a variety of different ways, such as a suction cup to attach to surface while in use or as a flat base to stand upright while in use. The grip portion may have a hole defined therein for hanging the brush on a peg or other projection.

In the assembled orientation that is depicted in FIGS. 1-2, the nipple brush assembly may be releaseably attached within the handle 30 in a variety of different ways, such as by an interference fit, a threaded attachment or any other suitable attachment mechanism. An interference fit would be constructed to withstand a withdrawal force when locked that would at least exceed the entire weight of brush system 10, so that the entire brush system 10 may be hung from grip portion of nipple brush assembly. Alternatively, a twist fit or snap-in fit connection could be provided in the base of the nipple brush.

When the nipple brush assembly 20 is stored within the recess of the brush handle 30, it is insulated against contact with germ-laden surfaces such as countertops, sinks, or other utensils. Likewise, the hole in grip portion of the handle enables the entire brush to be hung in a location where contact with other utensils or surface is unlikely.

The grip portion 30 may include an ornamental design, such as a heart-shaped design and/or any other suitable shape.

The modular brush system 10 includes a flexible neck portion 41 that may have a spine-like configuration. As shown in FIGS. 4-5, the flexible neck portion 42 may be configured to include a central post portion 44 and at least one gap 45 disposed concentric to the post 44. Various discs 43 can be constructed along the central post 44 to define various gaps 45 bordering each of the discs 43. The brush system 10 may be constructed to have an outer profile nearly contiguous with an outer surface of the handle 30 and the gaps 45 are bored into the top portion 40 at the neck 42 to define the spine-like configuration as shown in FIG. 4.

The spine-like structure is bounded by two walls, an upper concentric wall 46 and a lower concentric wall 47. Various discs 43 are provided between the two walls 46, 47. The various discs 43 are separated by a gap 45 having a predetermined space length L. For example, the top disc 43 is separated from the upper concentric wall 46 by a gap space 45 having a distance of L. The depth of the gap 45 is at a predetermined distance D inward of the outer wall of the brush.

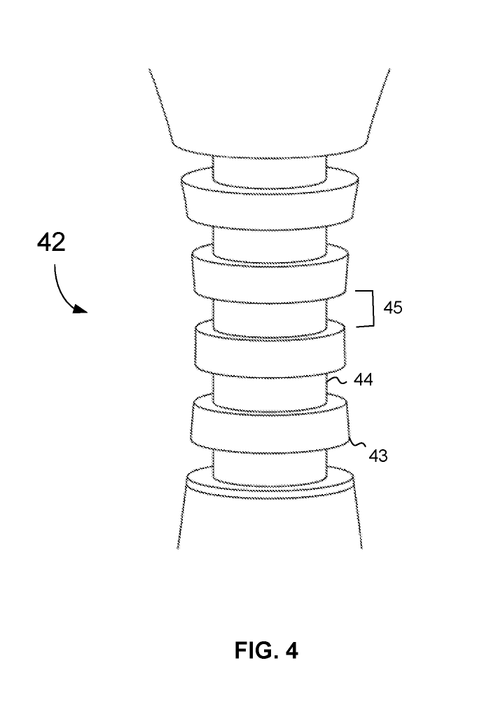

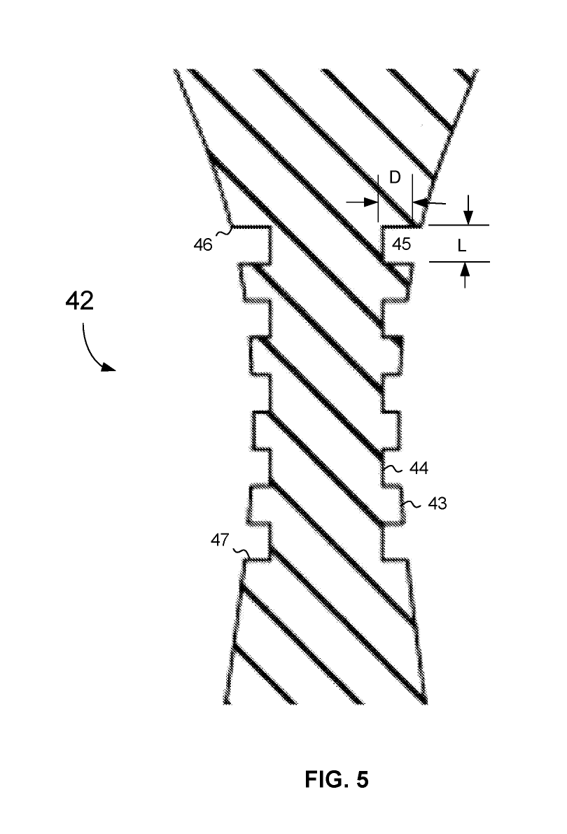

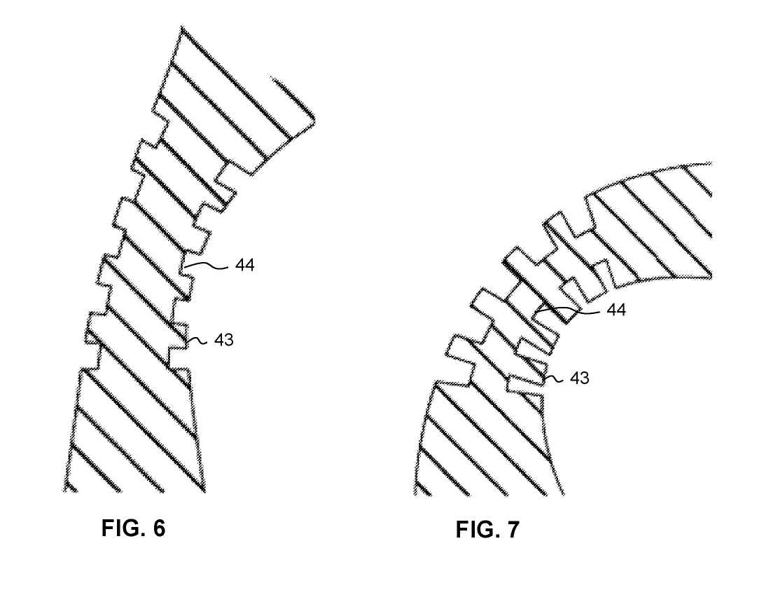

As shown in FIGS. 6 and 7, as the neck 42 of the brush is bent over to one side, the gaps 45 defined in the direction of the bend close up and the gaps on the outside of the neck of the brush open up. The combination of the dimension of the gaps, the space length L, the depth D, the material used for the substrate and the resilient material disposed between the gaps define the amount of bend that the neck of the handle will take.

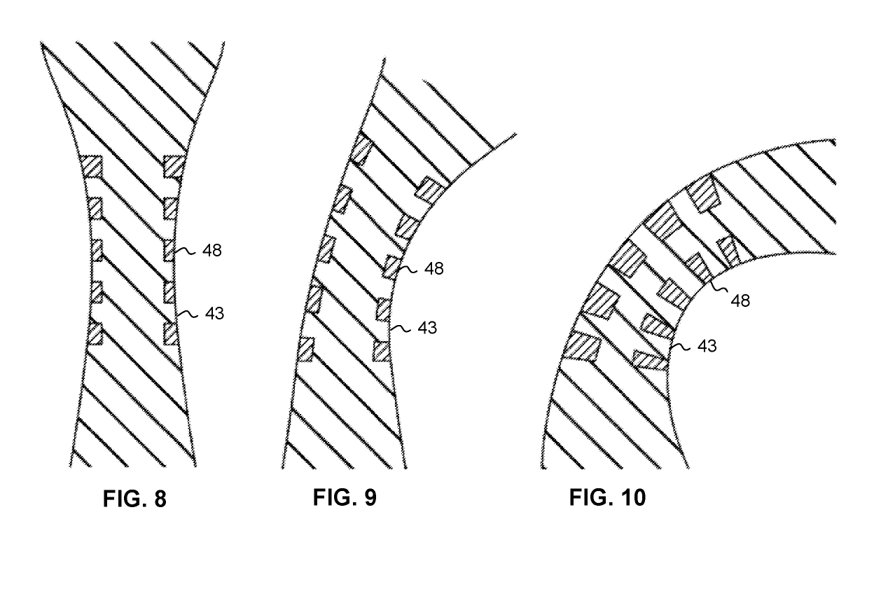

As shown in FIGS. 8-10, the gaps 45 between discs 43 may be filled with a material 48 having desired properties. If the material substrate 48 used is a material having higher flexibility properties, then the substrate will have the propensity to bend more. Likewise, if the resilient material 48 disposed in the gaps 44 between the discs 43 is soft, the neck 42 will have a higher propensity to bend. However, if the resilient material 48 disposed in the gaps between the discs is of a harder, less flexible material, the neck 42 will have a lower propensity to bend. In this manner, the flexibility of the brush 10 can be tailored to bend at a desired angle and with sufficient resiliency to rebound during use.

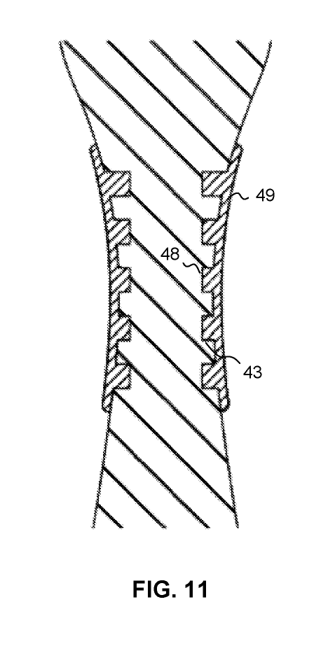

FIG. 11 illustrates another exemplary embodiment in which the resilient material 48 disposed in the gaps 45 between the discs 43 is connected by an outer sleeve portion 49 that interconnects each of the concentric plugs provided within the gaps 45. The outer sleeve portion 49 may be of the same or different material than the resilient material 48 within the gaps 45. Further, the discs 43 may not be visible from underneath the sleeve portion 49 thereby allowing for a more uniform external appearance along the sleeve portion 49.

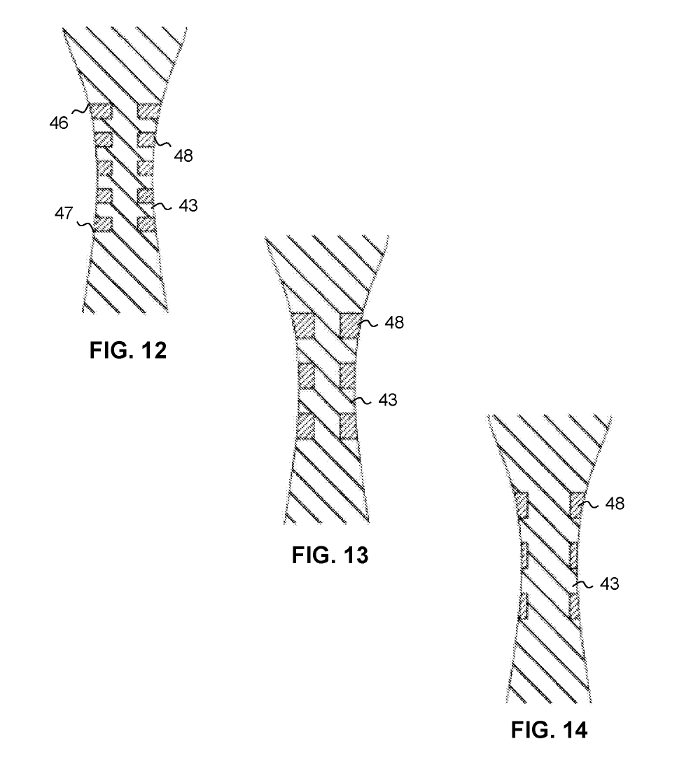

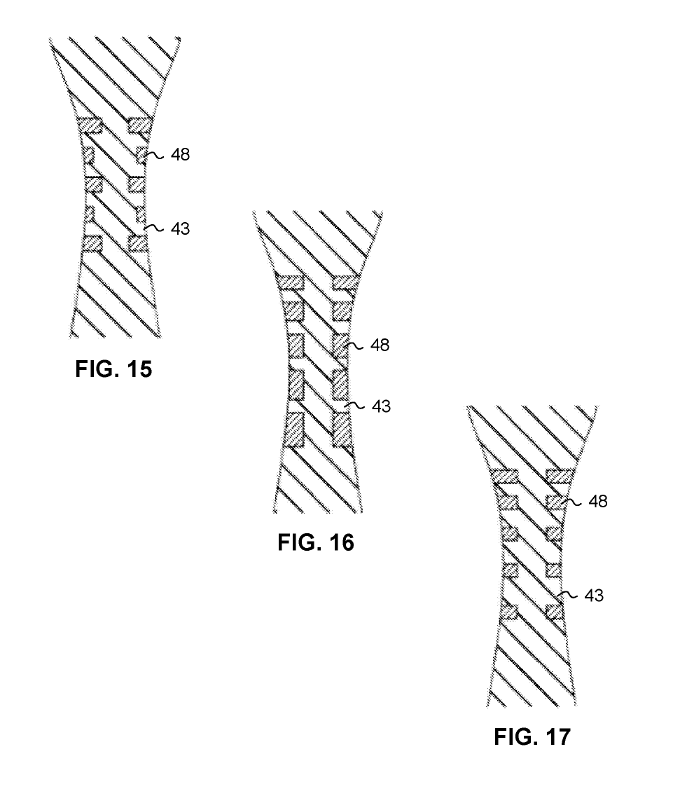

As shown in FIGS. 12-17, various geometries are possible for the spine-like configuration to vary the bend in the neck 42 of the brush system 10. As shown, the distance between the upper concentric wall 46 and the lower concentric wall 47 can be varied. The number of discs 43 can be modified between the two walls 46, 47 to vary the flexibility of the neck 42. The gap 45 and space length L between each of the discs 43 and/or the walls 46, 47 can be modified to vary the flexibility of the neck 42. The depth of the gap 45 can also be changed to vary the flexibility of the neck. Likewise, the predetermined distance D inward from the outer wall of the brush inward can be modified to vary the flexibility of the neck 42. In the exemplary embodiment of FIG. 12, each of the gap portions 45 contains a relatively equal amount of resilient material 48 and all discs 43 are similarly sized and equidistant from each other. In the exemplary embodiment of FIG. 13, each of the gap portions 45 contains a relatively equal amount of resilient material 48 but the gap portions are relatively large and the space between each gap portion 45 is large as well with only a few discs 43 being present. In the exemplary embodiment of FIG. 14, each of the gap portions 45 contains a relatively small depth of resilient material 48 and the discs 43 are relatively large and flat. In the exemplary embodiment of FIG. 15, the gap portions 45 alternate between large and small volumes of resilient material 48, and the discs 43 alternate in size correspondingly. In the exemplary embodiment of FIG. 16, the gap portions 45 steadily change from a long and narrow resilient material 48 to a relatively flat and large. In the exemplary embodiment of FIG. 17, each of the gap portions 45 contains an increasingly larger distance between the resilient material 48 with the depth of the resilient material 48 changing along the length of the flexible neck 42. One of ordinary skill in the art would appreciate these various parameters may be varied for particular flexibility characteristics, according to the present subject disclosure.

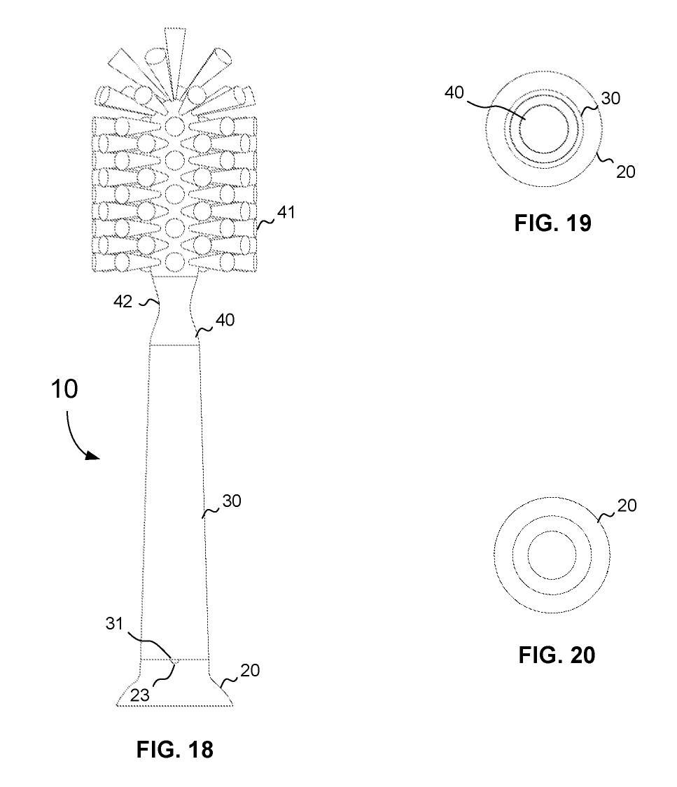

In another exemplary embodiment of the present subject matter, brush system 10 is shown in FIG. 18. This embodiment also includes a base portion 20, a handle portion 30, and a top portion 40, which includes bristles 41 and a flexible neck portion 42, as described in detail above. It should be noted that the flexible neck region 42 shown in FIGS. 18-25 have been drawn generically for sake of simplicity, but have the same optional disc-like or rib-like configurations as described above with respect to FIGS. 1- 17. There is a complementing configuration between the base portion 20 and handle portion 30 in that a notch 23 in base portion 20 receives an appropriately sized projection 31 in handle portion 30. The combination of the complementing notch 23 and projection 31 ensures a pre-determined and snug fit between the base portion 20 and handle portion 30, respectively.

FIGS. 19 and 20 show the top and bottom views respectively, of the brush system 10 (without the bristles) shown in FIG. 18. It should be noted that the low profile design of the brush system 10 allows for easy handling and storage.

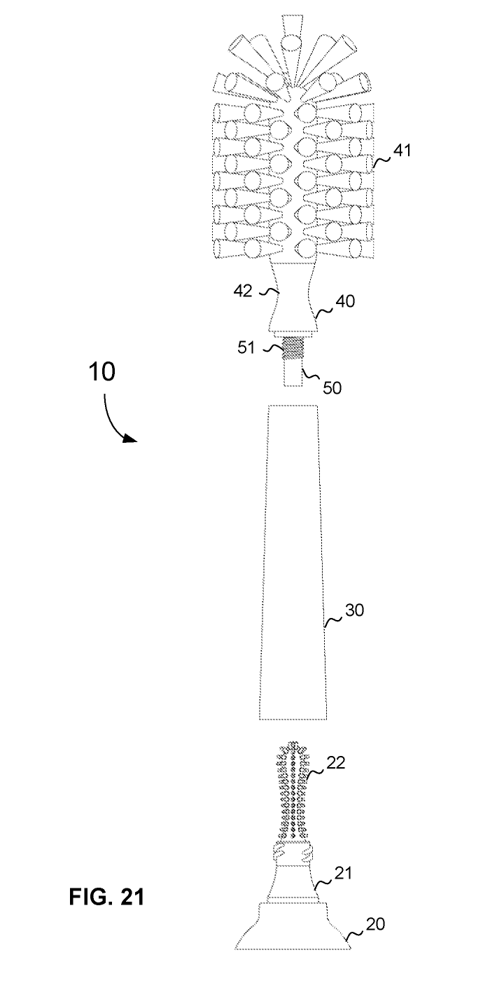

As shown in FIG. 21, the brush system 10 is designed to be modular with interchangeable and replaceable parts. For example, the base portion 20, handle portion 30, and top portion 40 may be replaced or exchanged with base, handle, and top portions of different configurations. Base portion 20 has a nipple brush 22 and a threaded portion 21 which mates with an internal thread in the bottom aperture end of handle portion 30. Top portion 40 includes bottle bristles 41, a flexible neck 42, and a projection 50 having a threaded portion 51 which mates with an internal thread at the top aperture end of handle portion 30.

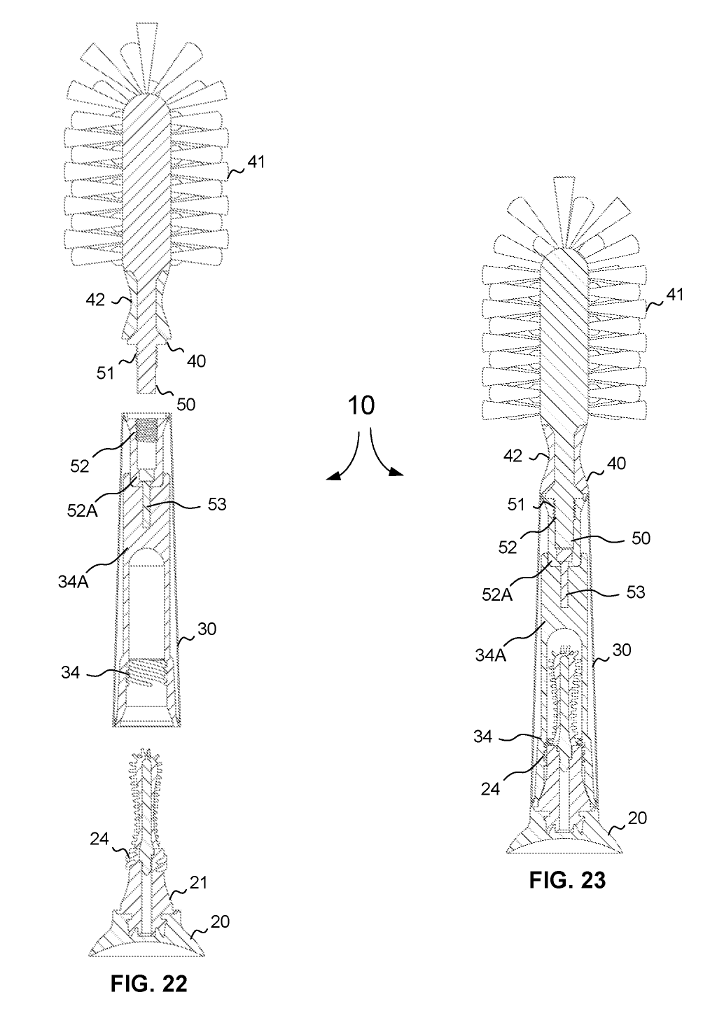

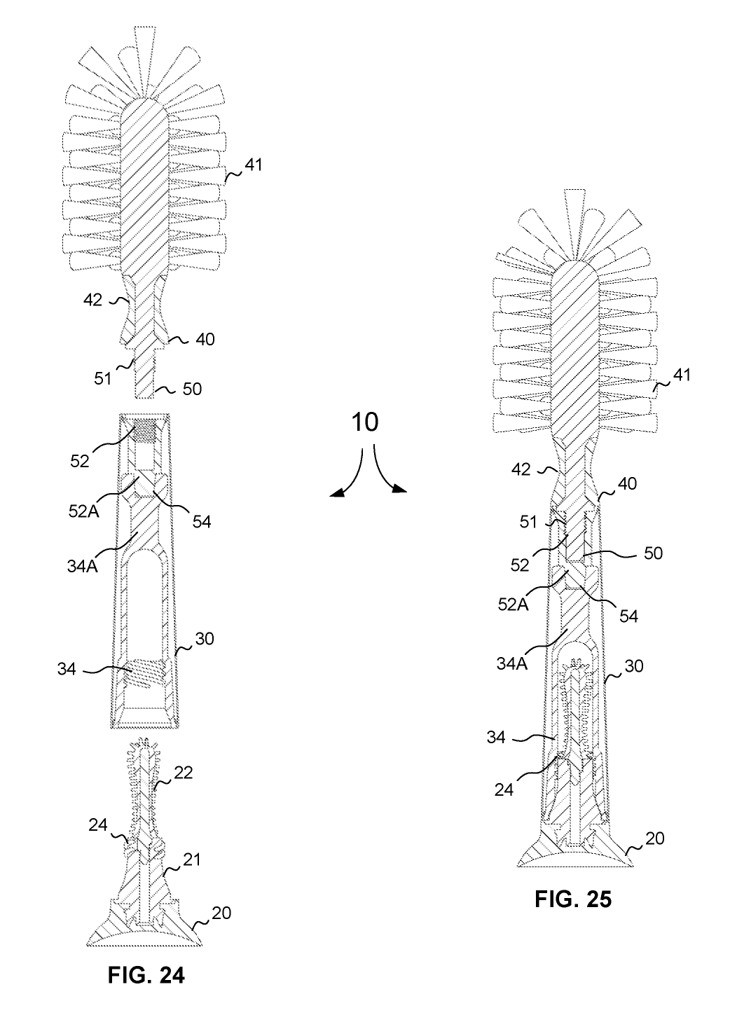

The internal mechanisms used to secure these various modular components with each other may be varied. FIGS. 22 and 23 show one exemplary internal mechanism, and FIGS. 24 and 25 show another exemplary internal mechanism.

FIGS. 22 and 23 show, through cross sectional views, one possible exemplary embodiment of the internal mechanism of the brush system 10 of FIG. 21. This embodiment 10 shows the threads 24 of a threaded portion 21 of base portion 20 mates with the threaded portion 34 within the second core portion 34A of handle portion 30. Similarly, a threaded portion 51 on projection 50 in the top portion 40 mates with the threaded portion 52 within the first core portion 52A of base portion 30. The configuration shown in FIGS. 22 and 23 includes a threaded fastener 53 which serves to retain the internal connection mechanism between the first core portion 52A and second core portion 34A of handle portion 30.

FIGS. 24 and 25 are similar to FIGS. 22 and 23, except that the internal mechanism between the first core portion 52A and second core portion 34A of the handle portion 30 includes no threaded fastener. The components 54 are bonded together in this embodiment. Other variations are also possible and within the purview of one having ordinary skill in the art.

As employed in this specification and annexed drawings, the term “or” is intended to mean an inclusive “or” rather than an exclusive “or.” Moreover, articles “a” and “an” as used in the subject specification and annexed drawings should generally be construed to mean “one or more” unless specified otherwise or clear from context to be directed to a singular form.

What has been described above includes examples of a low-profile assembly and method of installation that provide advantages of the subject disclosure. It is, of course, not possible to describe every conceivable combination of components or methodologies for purposes of describing the subject disclosure, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed is:

1. A device to scrub a container, comprising:
a rigid handle comprising a first core portion and a second core portion, the first and second core portions connected internally within the handle;
a flexible portion removably connected to the handle and including a resilient material of a predetermined hardness, the flexible portion adapted to bend relative to a longitudinal axis of the handle; and
a first brush operatively connected to the flexible portion and sized to efficiently scrub an inside of the container as the flexible portion bends.

2. The device of claim 1, further comprising a separable base portion attachable to the rigid handle.

3. The device of claim 2, wherein the base portion includes a second brush which is smaller than the first brush and is sized and configured to efficiently scrub an inside of a smaller container.

4. The device of claim 3, wherein the second brush is disposed within an interior chamber of the second core portion of the handle when not in use.

5. The device of claim 4, wherein the base portion attaches to the second core portion of the handle through friction fit.

6. The device of claim 4, wherein the base portion includes a threaded portion which mates with an internal thread on the second core portion of the handle.

7. The device of claim 6, wherein the flexible portion includes a threaded projection which mates with an internal thread in the first core portion of the handle, opposite the internal thread in the second core portion which mates with the base portion.

8. The device of claim 1, wherein the first core portion and the second core portion of the handle are connected through a threaded fastener.

9. The device of claim 1, wherein the first core portion and the second core portion of the handle are connected through internal bonding.

10. The device of claim 1, wherein the flexible portion has spine-like configuration.

11. The device of claim 10, wherein the spine-like configuration includes a plurality of adjacent discs.

12. The device of claim 11, wherein the plurality of discs are aligned so that their centers are on a longitudinal axis of the flexible portion.

13. The device of claim 10, wherein the discs have the same diameter and depth.

14. The device of claim 10, wherein the discs have varying diameters and depths.

15. The device of claim 10, wherein a gap is formed between adjacent discs.

16. The device of claim 1, wherein the resilient material extends beyond the flexible portion and into an outer sleeve portion.

17. The device of claim 16, wherein the outer sleeve is made of the resilient material.

18. A device to scrub a container, comprising:
a handle having a first core and a second core;
a flexible top portion removably connected to the handle with a resilient material of a predetermined hardness disposed in at least one gap, the flexible top portion adapted to bend at a predetermined angle relative to a longitudinal axis of the handle;
a brush operatively connected to the flexible portion and the first core within the handle, and sized to efficiently scrub an inside of the container as the flexible handle bends; and
a second brush operatively connected to the second core and received within the handle.

19. The device of claim 18, the flexible top portion having a spine-like configuration.

20. A device to scrub a container, comprising:
a handle having a first core and a second core;
a flexible top portion having a neck removably connected to the handle with a resilient material of a predetermined hardness disposed around the neck, the flexible top portion adapted to bend at a predetermined angle relative to a longitudinal axis of the handle;
a brush operatively connected to the flexible top portion and the first core within the handle, and sized to efficiently scrub an inside of the container as the flexible handle bends; and
a second brush operatively connected to the second core and received within the handle.
